(19) United States
(12) Patent Application Publication
(10) Pub. No.: US 2018/0074532 A1
(43) Pub. Date: Mar. 15, 2018

(54) REFERENCE VOLTAGE GENERATOR

(71) Applicant: FREESCALE SEMICONDUCTOR, INC., Austin, TX (US)

(72) Inventors: PRALAY MANDAL, Kolkata (IN); RAZA IMAM, Ghaziabad (IN); NISHANT SINGH THAKUR, Noida (IN)

(21) Appl. No.: 15/264,558

(22) Filed: Sep. 13, 2016

(51) Int. Cl. G05F 1/46

(52) U.S. Cl. CPC G05F 1/468

(57) ABSTRACT

A reference voltage generator includes first through sixth transistors and an operational amplifier. The first and second transistors provide first and second voltages to the operational amplifier, respectively. The operational amplifier generates a control voltage at its output terminal, which then is provided to the gate terminals of the second and third transistors. The output terminal of the operational amplifier also is connected to the fifth and sixth transistors by way of trimming switches. The trimming switches provide fine trimming control of a reference output voltage.

### BACKGROUND

The present invention relates generally to integrated circuits, and, more particularly, to a reference voltage generator used in an integrated circuit.

An integrated circuit (IC) includes a reference voltage generator to regulate supply voltages in the IC. The reference voltage generator generates and provides a reference output voltage to circuits such as power management circuits, power-on-reset (POR) circuits, high and low voltage detectors, analog-to-digital converters (ADCs), digital-to-analog converters (DACs), and the like. Examples of the reference voltage generators include a forward biased diode, a Brokaw bandgap reference circuit, a shunt type bandgap reference circuit, a series type bandgap reference circuit, a buried Zener reference circuit, and the like.

To ensure accurate operation, it is essential that the reference voltage generates receive a reference output voltage that has minimum variation i.e. the reference output voltage is within a predetermined voltage range. However, various factors such as variations in an operating temperature, process variations, and second order effects of transistors may alter the reference output voltage, which can cause aberrations in the operation of the IC.

The value of the reference output voltage changes with a change in the IC operating temperature as well as an increase in the temperature of the operating environment. When values of the reference output voltage are plotted against temperature, a temperature dependent curve of the reference output voltage is obtained. The reference output voltage should not be effected by the temperature changes, and thus have minimum peak to peak variation. As the reference output voltage is very important for an accurate performance, various temperature curve trimming techniques and algorithms have been implemented to counter the factors that alter the reference output voltage. The temperature curve trimming techniques ensure that the reference output voltage is within a predetermined voltage range.

A conventional reference voltage generator includes first and second bipolar junction transistors (BJTs), an operational amplifier (op-amp), multiple resistors, and multiple current sources. The BJTs function as diodes. The current sources, which are connected to the BJTs, receive a supply voltage and bias the first and second BJTs. The op-amp receives first and second voltages from the first and second BJTs, respectively, and generates a control voltage. The control voltage regulates the current sources that alter the bias of the BJTs. The reference output voltage is output at a node formed by the current sources and the first BJT. The multiple resistors, which are connected to the BJTs, trim the reference output voltage, where the reference output voltage is represented by the following equation:

V_{REF}=V_{BE}+(k*ΔV_{BE})

where:
k is a gain factor which is equal to a resistor ratio,
V_{BE} is a BJT base-emitter voltage drop of either the first BJT or the second BJT, and
ΔV_{BE} is a voltage difference between the first and second voltages of the first and second BJTs, respectively.

Resistance values of the multiple resistors may be varied, thereby altering the resistor ratio. Thus, temperature curve trimming techniques, typically, include adjusting the values of the gain factor k and the voltage difference ΔV_{BE} to maintain the reference output voltage V_{REF} within the predetermined voltage range.

One known method to implement temperature curve trimming is the use of multiple resistors and adjusting the resistor ratio. The resistor ratio is controlled by trimming switches, which are typically transistor switches. The trimming switches are placed either in parallel or in series with the resistors. However, it is essential that the trimming switches have very low resistance values. However, the trimming switches that have lower resistance values also have larger areas and thus consume a considerable amount of valuable silicon area of the IC.

Another known method to implement the temperature curve trimming is to use multiple BJTs and connect the trimming switches in series with the BJTs. The BJTs function as current sources in the reference voltage generator. Multiple BJTs are used to achieve accurate temperature curve trimming. However, the temperature curve trimming achieved by the BJTs is compressed logarithmically, and due to the logarithmic compression, the trimming achieved by a single BJT is very small. Therefore, the number of BJTs required to achieve good temperature curve trimming is large. Further, the resistance of the trimming switches has to be low. The BJTs and the low resistance trimming switches collectively consume a large silicon area.

It would be advantageous to have a reference voltage generator that provides a reference output voltage that is within a predetermined voltage range and does not consume a lot of valuable silicon area.

### BRIEF DESCRIPTION OF THE DRAWINGS

The following detailed description of the preferred embodiments of the present invention will be better understood when read in conjunction with the appended drawings. The present invention is illustrated by way of example, and not limited by the accompanying figures, in which like references indicate similar elements.

FIG. 1 is a schematic circuit diagram of a reference voltage generator in accordance with an embodiment of the present invention; and

FIG. 2 is a schematic block diagram of a power management controller that includes the reference voltage generator of FIG. 1 in accordance with an embodiment of the present invention.

### DETAILED DESCRIPTION

The detailed description of the appended drawings is intended as a description of the currently preferred embodiments of the present invention, and is not intended to represent the only form in which the present invention may be practiced. It is to be understood that the same or equivalent functions may be accomplished by different embodiments that are intended to be encompassed within the spirit and scope of the present invention.

In one embodiment, the present invention provides a reference voltage generator for generating a reference output voltage. The reference voltage generator includes first through sixth transistors and an operational amplifier (op-amp). The first transistor has a collector connected to ground, a base connected to its collector, and an emitter that generates a first voltage. The second transistor has a collector connected to ground, a base connected to its collector, and an emitter terminal that generates a second voltage. The op-amp includes an inverting terminal connected to the emitter of the first transistor for receiving the first voltage, a non-inverting terminal connected to the emitter of the second transistor by way of a first resistor for receiving the second voltage, and an output terminal at which is generated a control voltage. The third transistor has a gate connected to the output terminal of the op-amp for receiving the control voltage, a source connected to a biasing voltage, and a drain connected to the emitter of the first transistor by way of second and third resistors for generating a first current. The fourth transistor has a gate connected to the output terminal of the op-amp for receiving the control voltage, a source connected to the biasing voltage, a drain connected to the emitter of the second transistor by way of fourth and fifth resistors for generating a second current. The fifth transistor has its gate connected to the output terminal of the op-amp by way of a first switch for receiving the control voltage, a source connected to the biasing voltage, and a drain connected to the emitter terminal of the first transistor by way of the second and third resistors for generating a third current. The drain of the fifth transistor generates the third current when the first switch is closed. The sixth transistor has its gate connected to the output terminal of the op-amp by way of a second switch for receiving the control voltage, a source connected to the biasing voltage, and a drain connected to the emitter terminal of the second transistor by way of the fourth and fifth resistors for generating a fourth current. The drain of the sixth transistor generates the fourth current when the second switch is closed. Further, the drains of the fourth and sixth transistors form a node to output the reference output voltage. The first through fourth currents control the reference output voltage.

In another embodiment, the present invention provides a power management controller for monitoring a supply voltage. The power management controller includes a reference voltage generator for generating a reference output voltage. The reference voltage generator includes first through sixth transistors and an op-amp. The first transistor has its collector connected to ground, a base connected to the collector, and an emitter that generates a first voltage. The second transistor has its collector connected to ground, a base connected to its collector, and an emitter that generates a second voltage. The op-amp includes an inverting terminal connected to the emitter of the first transistor for receiving the first voltage, a non-inverting terminal connected to the emitter of the second transistor by way of a first resistor for receiving the second voltage, and an output terminal at which a control voltage is generated. The third transistor has a gate connected to the output terminal of the op-amp for receiving the control voltage, a source connected to a biasing voltage, and a drain connected to the emitter of the first transistor by way of second and third resistors for generating a first current. The fourth transistor has its gate connected to the output terminal of the op-amp for receiving the control voltage, a source connected to the biasing voltage, a drain connected to the emitter of the second transistor by way of fourth and fifth resistors for generating a second current. The fifth transistor has a gate connected to the output terminal of the op-amp by way of a first switch for receiving the control voltage, a source connected to the biasing voltage, a drain connected to the emitter of the first transistor by way of the second and third resistors for generating a third current. The drain of the fifth transistor generates the third current when the first switch is closed. The sixth transistor has a gate connected to the output terminal of the op-amp by way of a second switch for receiving the control voltage, a source connected to the biasing voltage, a drain connected to the emitter of the second transistor by way of the fourth and fifth resistors for generating a fourth current. The drain of the sixth transistor generates the fourth current when the second switch is closed. The drains of the fourth and sixth transistors form a node to output the reference output voltage, and the first through fourth currents control the reference output voltage.

Various embodiments of the present invention provide a reference voltage generator. The reference voltage generator includes first through sixth transistors, an op-amp, first through fifth resistors, and first through fifth switches. A collector and base of both the first and second transistors are connected to ground. An emitter of the first transistor is connected to an inverting terminal of the op-amp, and an emitter of the second transistor is connected to a non-inverting terminal of the op-amp by way of the first resistor. An output terminal of the op-amp is connected to gates of the third and fourth transistors. The output terminal of the op-amp is also connected to gates of the fifth and sixth transistors by way of the first and second switches. Drains of the third and fifth transistors are connected to the emitter of the first transistor by way of the second and third resistors. Drains of the fourth and sixth transistors are connected to the emitter of the second transistor by way of the first, fourth, and fifth resistors. The output terminal of the op-amp is connected to the gates of the fifth and sixth transistors by way of the first and second switches, respectively. The third, fourth, and fifth switches are connected across the first, third, and fifth resistors, respectively. The drains of the fourth and sixth transistors along with the fourth resistor form a node to output the reference output voltage.

The first through fifth switches trim the reference output voltage to achieve a temperature-stable reference output voltage. The third through sixth transistors are metal-oxide semiconductor field effect transistors (MOSFETs). Thus, the third through sixth transistors consume very little silicon area. The first and second switches control the fifth and sixth transistors, respectively. The third, fourth, and fifth switches control the first, third, and fifth resistors, respectively. The first through fifth switches facilitate temperature curve trimming of the reference voltage generator. Further, the first and second switches are connected to the gates of the third through sixth transistors. As no current flows through the gates of the third through sixth transistors and the first and second switches, the first and second switches also consume very little silicon area. Furthermore, the first and second switches, which control the fifth and sixth transistors, respectively, provide fine trimming control of the reference output voltage. The third, fourth, and fifth switches, which control the first, third, and fifth resistors, respectively, provide coarse trimming control of the reference output voltage. Thus, the coarse and fine trimming control provides an accurate reference output voltage with very little variation.

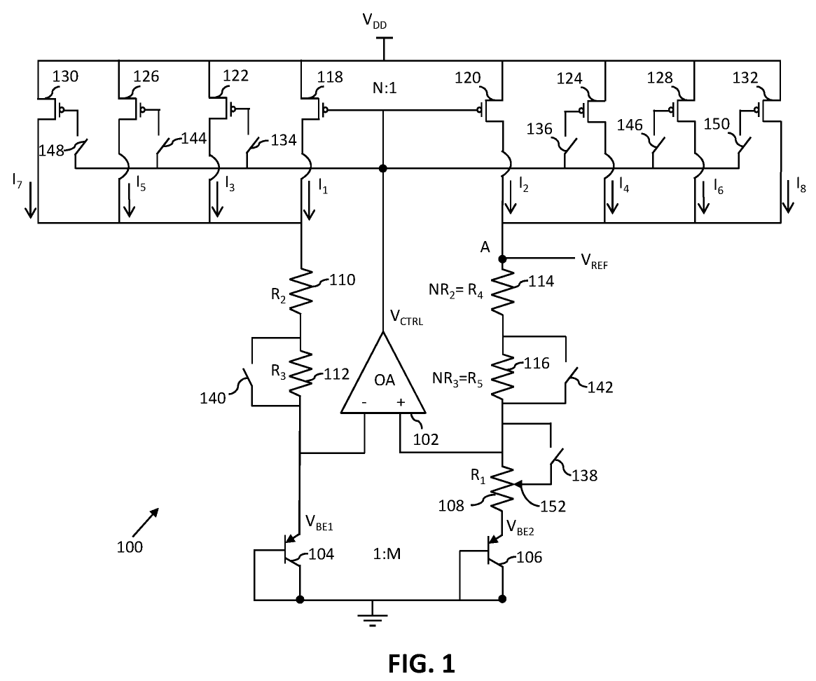

Referring now to FIG. 1, a schematic circuit diagram of a reference voltage generator 100 in accordance with an embodiment of the present invention is shown. The reference voltage generator 100 (also referred to as a bandgap reference (BGR) voltage generator 100) includes an op-am 102, first and second bipolar junction transistors (BJTs) 104 and 106, first through fifth resistors 108-116, first through eighth MOSFETs 118-132, first through ninth trimming switches 134-150, and a potentiometer 152. The reference voltage generator 100 generates and provides a reference output voltage to circuits such as power management circuits, power-on-reset (POR) circuits, low voltage detectors, high voltage detectors, ADCs, DACs, and the like.

In the presently preferred embodiment, the collector and base terminals of each of the first and second BJTs 104 and 106 are connected to ground. The first and second BJTs 104 and 106 function as diodes. In the presently preferred embodiment, an emitter area of the second BJT 106 is larger than the emitter area of the first BJT 104. For example, the emitter area of the second BJT 106 may be M times the emitter area of the first BJT 104. The second BJT 106 may be a composite transistor made of “n” individual transistors that are similar to the first BJT 104. The first and second BJTs 104 and 106 preferably are P-N-P BJTs. In another embodiment, the first and second BJTs 104 and 106 are N-P-N BJTs.

The first BJT 104 generates a first voltage V_{BE1}, which is the voltage difference between its emitter and base terminals. The second BJT 106 generates a second voltage V_{BE2}, which is the voltage difference between its emitter and base terminals. The first and second emitter areas of the first and second BJTs 104 and 106, respectively, are not equal in size. Hence, the first voltage V_{BE1} is not equal to the second voltage V_{BE2}.

The emitter terminal of the first BJT 104 is connected to the third resistor 112 and the emitter terminal of the second BJT 106 is connected to the first resistor 108. The second and third resistors 110 and 112 are connected in series. The first, fourth, and fifth resistors 108, 114, and 116 are connected in series. The first through fifth resistors 108-116 each have first through fifth resistance values R₁-R₅, which preferably are not equal to each other. The fourth resistance value R₄ is N times the second resistance value R₂ i.e. NR₂=R₄; the fifth resistance value R₅ is N times the third resistance value R₃ i.e. NR₃=R₅. The third, fourth, and fifth trimming switches 138, 140, and 142 are connected across the first, third, and fifth resistors 108, 112, and 116, respectively. The first resistance value R₁ is calibrated using a combination of the third trimming switch 138 and the potentiometer 152.

The op-amp 102 has an inverting terminal connected to the emitter terminal of the first BJT 104, a non-inverting terminal connected to the emitter terminal of the second BJT 106 by way of the first resistor 108, and an output terminal. The op-amp 102 receives the first voltage V_{BE1} at the inverting terminal and the second voltage V_{BE2} at the non-inverting terminal, and generates a control voltage V_{CTRL} at its output terminal.

In one embodiment, the first through eighth MOSFETs 118-132 are P-channel metal-oxide semiconductor (PMOS) transistors. The channel width of the first MOSFET 118 is greater than the channel width of the second MOSFET 120. For example, the channel width of the first MOSFET 118 may be N times the channel width of the second MOSFET 120. Gate terminals of the first and second MOSFETs 118 and 120 are connected to the output terminal of the op-amp 102 to receive the control voltage V_{CTRL}. The channel widths of the third through eighth MOSFETs 122-132 are substantially the same. In another embodiment, the channel widths of the third through eighth MOSFETs 122-132 may differ and may have either an increasing or decreasing channel width gradient.

Source terminals of the first through eighth MOSFETs 118-132 are connected to a bias voltage V_{DD}. Drain terminals of the first, third, fifth, and seventh MOSFETs 118, 122, 126, and 130 are connected to the second resistor 110. Drain terminals of the second, fourth, sixth, and eighth MOSFETs 120, 124, 128, and 132 are connected to the fourth resistor 114. Gate terminals of the third, fourth, fifth, sixth, seventh, eighth MOSFETs 122, 124, 126, 128, 130, and 132 are connected to the output terminal of the op-amp 102 by way of the first, second, sixth, seventh, eighth, and ninth trimming switches 134, 136, 144, 146, 148, and 150, respectively. The first through eighth MOSFETs 118-132 generate first through eighth currents I₁-I₈, respectively. The first through eighth currents I₁-I₈ are proportional-to-absolute-temperature (PTAT) currents. A node is formed at the drain terminal of the second MOSFET 120 and the fourth resistor 114. The reference output voltage V_{REF} is output at the node A.

In operation, the first and second MOSFETs 118 and 120 receive the bias voltage V_{DD} and generate the first and second currents I₁ and I₂, respectively. The first and second BJTs 104 and 106 receive the first and second currents I₁ and I₂, respectively and switch ON. The first and second BJTs 104 and 106 generate the first and second voltages V_{BE1} and V_{BE2}. The op-amp 102 receives the first and second voltages V_{BE1} and V_{BE2} and generates the control voltage V_{CTRL} based on a voltage difference between the first and second voltages V_{BE1} and V_{BE2}. The gate terminals of the first and second MOSFETs 118 and 120 receive the control voltage V_{CTRL} to regulate the first and second currents I₁ and I₂, thereby generating the reference voltage V_{REF} at the node A. The op-amp 102 continues to sense the voltage difference between the first and second voltages V_{BE1} and V_{BE2} and provide the control voltage V_{CTRL} to the first and second MOSFETs 118 and 120 to generate the reference output voltage.

The value of the reference output voltage V_{REF} changes with a change in the operating temperature of the IC due to either an increase in the temperature of the IC and/or an increase in temperature in the operating environment. When values of the reference output voltage V_{REF} are plotted against varying temperature values, a temperature dependent curve of the reference output voltage V_{REF} (also referred to as a “temperature curve”) is obtained. An ideal temperature curve has minimum peak to peak variations indicating that the reference output voltage V_{REF} is independent of changes in temperature. However, generally, the temperature curve has multiple peak to peak variations due to changes in the operating temperature. Hence, the reference voltage generator 100 performs temperature curve trimming to reduce the peak to peak variations in the temperature curve.

The first, third, and fifth resistors 108, 112 and 116 and the third through eighth MOSFETs 122-132 together facilitate the trimming of the temperature curve of the reference voltage generator 100. The first through ninth trimming switches 134-150 control the trimming operations of the temperature curve. The third through fifth trimming switches 138-142 provide a coarse trimming control of the temperature curve. The first, second, sixth, seventh, eighth, and ninth trimming switches 134, 136, 144, 146, 148, and 150 provide fine trimming control of the temperature curve.

The reference output voltage V_{REF} is calculated by the following equation:

V_{REF}=V_{BE1}+V_{T} ln(NM)*[(N*R₂+N*R₃)/R₁] (1)

where,
V_{REF}=the reference output voltage,

V_{BE1}=the first voltage generated by the first BJT 104,

V_{T}=a thermal voltage,

R₂=the second resistance value,

N*R₂=the fourth resistance value R₄, which is N times the second resistance value R₂,

R₃=the third resistance value,

N*R₃=the fifth resistance value, which is N times the third resistance value R₃,

R₁=the first resistance value,

N=an integer value by which the channel width of the first MOSFET 118 is greater than the channel width of the second MOSFET 120,

M=an integer value by which the emitter area of the second BJT 106 is greater than the emitter area of the first BJT 104, and

ln(NM)*[(N*R₂+N*R₃)/R₁] is a gain factor of the reference voltage generator 100. The first through ninth trimming switches 134-150 control the gain factor, and consequently control the trimming of the reference output voltage V_{REF}.

The thermal voltage V_{T} is calculated by the following equation:

V_{T}=kT/q (2)

where,

k=Boltzmann's constant,

q=a value of electrical charge on an electron, and

T=a value of the operating temperature of the IC in degrees Kelvin.

The value of the thermal voltage V_{T} is generally considered to be constant. A typical value of the thermal voltage V_{T} at an operating temperature of 300° K is 0.025 volts (V).

The first through ninth trimming switches 134-150 have no control over the first voltage V_{BE1} as it is the emitter to base voltage of the first BJT 104. The first voltage V_{BE1} is a complementary-to-absolute-temperature (CTAT) voltage. Hence, the value of the reference output voltage V_{REF} is controlled by changing the value of the expression ln(NM)*[(N*R₂+N*R₃)/R₁], thus, by changing the first through third resistance values R₁-R₃.

The third through fifth trimming switches 138-142 provide coarse control of the first through third resistance values R₁-R₃. When the third trimming switch 138 is switched OFF, the first resistor 108 is connected to the fifth resistor 116 and the second BJT 106, and the second current I₂ flows through the first resistor 108. Thus, the value of the expression (N*R₂+N*R₃)/R₁ decreases, thereby decreasing the value of the reference output voltage V_{REF}. When the third trimming switch 138 is turned ON, the first resistor 108 is bypassed, and the first resistance value R₁ is reduced in the expression (N*R₂+N*R₃)/R₁. Thus, the value of the expression (N*R₂+N*R₃)/R₁ increases, thereby increasing the value of the reference output voltage V_{REF}. In another embodiment, the potentiometer 152 increases or decreases the first resistance value R₁, thereby decreasing or increasing the value of the expression (N*R₂+N*R₃)/R₁, respectively.

When the fourth trimming switch 140 is switched OFF, the third resistor 112 is connected to the first BJT 104, and the first current I₁ flows through the third resistor 112. Thus, the value of the expression (N*R₂+N*R₃)/R₁ decreases, thereby decreasing the value of the reference output voltage (V_{REF}). When the fourth trimming switch 140 is switched ON, the third resistor 112 is bypassed, and the third resistance value R₃ is reduced in the expression (N*R₂+N*R₃)/R₁. Thus, the value of the expression (N*R₂+N*R₃)/R₁ decreases, thereby decreasing the value of the reference output voltage V_{REF}.

When the fifth trimming switch 142 is switched OFF, the fifth resistor 116 is connected to the fourth and first resistors 114 and 108, and the first current I₁ flows through the fifth resistor 116. Thus, the value of the expression (N*R₂+N*R₃)/R₁ decreases, thereby decreasing the value of the reference output voltage V_{REF}. When the fifth trimming switch 142 is switched ON, the fifth resistor 116 is bypassed, and the fifth resistance value R₅ (N*R₃) is reduced in the expression (N*R₂+N*R₃)/R₁, thereby decreasing the value of the reference output voltage V_{REF}. Thus, the third through fifth trimming switches 138-142 control the reference output voltage V_{REF}. Since, the reference output voltage V_{REF} is directly proportional to the term (N*R₂+N*R₃)/R₁, the third through fifth trimming switches 138-142 provide coarse trimming control of the value of the reference output voltage V_{REF}. It will be apparent to a person skilled in the art that the value of N is selected to achieve the desired coarse control over the reference output voltage V_{REF}.

The first, second, sixth, seventh, eighth, and ninth trimming switches 134, 136, 144, 146, 148, and 150 fine control the value of the expression ln(MN) of the equation (1). The channel width of the first MOSFET 118 is N times the channel width of the second MOSFET 120. Thus, a ratio of the channel width of the first MOSFET 118 to the channel width of the second MOSFET 120 is N:1. In one embodiment, the first MOSFET 118 is a composite MOSFET that includes N number of the second MOSFETs 120 connected in parallel, thereby achieving the ratio of N:1. A first fine trimming branch includes the first, third, fifth, and seventh MOSFETs 118, 122, 126, and 130. A second fine trimming branch includes the second, fourth, sixth, and eighth MOSFETs 120, 124, 128, and 132.

When the first trimming switch 134 is switched ON, the third MOSFET 122 is connected between the bias voltage V_{DD} and the second resistor 110. Thus, a ratio of a sum of the channel widths of the first and third MOSFETs 118 and 122 to the channel width of the second MOSFET 120 becomes (N+1):1. Thus, the expression ln(MN) is now ln [M(N+1)]. It will be apparent to a person skilled in the art that the value of the expression ln [M(N+1)] has increased, thereby increasing the value of the reference output voltage (V_{REF}). Similarly, multiple MOSFETs of the first fine trimming branch may be switched ON, thereby increasing the value of the reference output voltage (V_{REF}).

Alternatively, when the second trimming switch 136 is switched ON, the fourth MOSFET 124 is connected between the bias voltage V_{DD} and the fourth resistor 114. Thus, a ratio of the channel width of the first MOSFET 118 to a sum of the channel widths of the second and fourth MOSFETs 120 and 124 becomes N:2. It will be apparent to a person skilled in the art that the value of the expression ln(MN) decreases with the connection of the fourth MOSFET 124, thereby decreasing the value of the reference output voltage V_{REF}. Similarly, multiple MOSFETs of the second fine trimming branch may be switched ON, thereby decreasing the value of the reference output voltage V_{REF}. Due to the logarithmic function, large variations in the value of N generate small variations in the value of the reference output voltage V_{REF}. Thus, the first, second, sixth, seventh, eighth, and ninth trimming switches 134, 136, 144, 146, 148, and 150 provide fine trimming control of the reference output voltage V_{REF}.

The reference voltage generator 100 provides accurate control over the reference output voltage V_{REF}. The reference output voltage V_{REF} is controlled by the first through ninth trimming switches 134-150 to achieve the temperature curve with minimum peak to peak variation. The fine and coarse trimming control performed using the first through ninth trimming switches 134-150 ensure that the desired temperature curve of the reference output voltage V_{REF} is obtained. The first, second, sixth, seventh, eighth, and ninth trimming switches 134, 136, 144, 146, 148, and 150 are connected to the gate terminals of the third though eighth MOSFETs 122-132. Since current does not flow through the gate terminals of the third though eighth MOSFETs 122-132, the size of the first, second, sixth, seventh, eighth, and ninth trimming switches 134, 136, 144, 146, 148, and 150 may be very small. Thus, the first, second, sixth, seventh, eighth, and ninth trimming switches 134, 136, 144, 146, 148, and 150 consume very little silicon area. The third though eighth MOSFETs 122-132 also consume very little silicon area and multiple MOSFETs may be connected in the first and second fine trimming branches without consuming a large silicon area. Thus, the layout design of the reference voltage generator 100 is cost effective in lower technology nodes such as 22 nanometer (22 nm), 14 nanometer (14 nm), and the like. Finally, the current mismatch in the first and second fine trimming branches is less disruptive due to the logarithmic compression, thereby achieving an accurate reference output voltage (V_{REF}).

The first through eighth MOSFETs 118-132 of the first and second fine trimming branches function as current sources in the reference voltage generator 100. The first through eighth MOSFETs 118-132 provide fine trimming control of the temperature curve of the reference voltage generator 100. Thus, the trimming operations of the reference voltage generator 100 are current-controlled.

In another embodiment, the first through ninth trimming switches 134-150 are dummy MOSFETs. The dummy MOSFETs may also be used as the current sources for trimming the temperature curve.

In yet another embodiment, the first through ninth trimming switches 134-150 may be programmable switches. The switching operations of the first through ninth trimming switches 134-150 may be controlled by either a microprocessor or a microcontroller based on the temperature curve requirement of the IC to which the reference voltage generator 100 is connected or part of. The first through ninth trimming switches 134-150 may be thermometric switches controlled by the temperature variations of the surroundings and the IC.

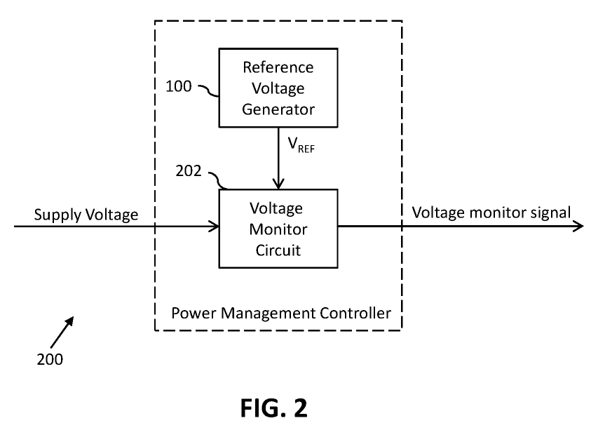

Referring now to FIG. 2, a schematic block diagram of a power management controller (PMC) 200 in accordance with an embodiment of the present invention is shown. The PMC 200 includes a voltage monitor circuit 202 and the reference voltage generator 100. The voltage monitor circuit 202 is connected to the reference voltage generator 100 to receive the reference output (V_{REF}).

The voltage monitor circuit 202 receives a supply voltage and compares the supply voltage with the reference output voltage (V_{REF}) to generate a voltage monitor signal. The voltage monitor signal is indicative of variations in the supply voltage with respect to the reference output voltage (V_{REF}). The voltage monitor signal may be used by a supply voltage regulator to calibrate the supply voltage based on the voltage monitor signal.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

1. A reference voltage generator for generating a reference output voltage, comprising:
a first transistor having a collector terminal connected to ground, a base terminal connected to the collector terminal, and an emitter terminal that generates a first voltage;
a second transistor having a collector terminal connected to ground, a base terminal connected to the collector terminal, and an emitter terminal that generates a second voltage;
an op-amp having an inverting terminal connected to the emitter terminal of the first transistor for receiving the first voltage, a non-inverting terminal connected to the emitter terminal of the second transistor by way of a first resistor for receiving the second voltage, and an output terminal for generating a control voltage;
a third transistor having a gate terminal connected to the output terminal of the op-amp for receiving the control voltage, a source terminal connected to a biasing voltage, and a drain terminal connected to the emitter terminal of the first transistor by way of second and third resistors for generating a first current, wherein the second and third resistors are connected in series;
a fourth transistor having a gate terminal connected to the output terminal of the op-amp for receiving the control voltage, a source terminal connected to the biasing voltage, a drain terminal connected to the emitter terminal of the second transistor by way of fourth and fifth resistors for generating a second current, wherein the fourth and fifth resistors are connected in series with each other and with the first resistor;
a fifth transistor having a gate terminal connected to the output terminal of the op-amp by way of a first switch for receiving the control voltage, a source terminal connected to the biasing voltage, and a drain terminal connected to the emitter terminal of the first transistor by way of the second and third resistors for generating a third current, wherein the drain terminal of the fifth transistor generates the third current when the first switch is closed; and
a sixth transistor having a gate terminal connected to the output terminal of the op-amp by way of a second switch for receiving the control voltage, a source terminal connected to the biasing voltage, a drain terminal connected to the emitter terminal of the second transistor by way of the fourth and fifth resistors for generating a fourth current, wherein the drain terminal of the sixth transistor generates the fourth current when the second switch is closed, wherein the drain terminals of the fourth and sixth transistors form a node to output the reference output voltage, and wherein the first through fourth currents control the reference output voltage.

2. The reference voltage generator of claim 1, wherein the first and second transistors comprise bipolar junction transistors (BJT).

3. The reference voltage generator of claim 1, wherein an area of the emitter area of the second transistor is at least two times an area of the emitter of the first transistor.

4. The reference voltage generator of claim 1, wherein the third through sixth transistors comprise metal-oxide semiconductor field effect transistors (MOSFET).

5. The reference voltage generator of claim 1, wherein a channel width of the third transistor is at least two times a channel width of the fourth transistor, and a channel width of the fifth transistor is at least two times a channel width of the sixth transistor.

6. The reference voltage generator of claim 1, wherein the first through fourth currents are proportional-to-absolute temperature (PTAT) currents.

7. The reference voltage generator of claim 1, wherein the fifth and sixth transistors fine calibrate the reference output voltage by way of the first and second switches.

8. The reference voltage generator of claim 1, wherein the reference voltage generator further includes a third switch connected in parallel with the first resistor, a fourth switch connected in parallel with the third resistor, and a fifth switch connected in parallel with the fifth resistor.

9. The reference voltage generator of claim 8, wherein the first, third, and fifth resistors coarse calibrate the reference output voltage by way of the third through fifth switches.

10. A power management controller for monitoring a supply voltage, comprising:
a reference voltage generator for generating a reference output voltage, comprising:
a first transistor having a collector terminal connected to ground, a base terminal connected to the collector terminal, and an emitter terminal that generates a first voltage;
a second transistor having a collector terminal connected to ground, a base terminal connected to the collector terminal, and an emitter terminal that generates a second voltage;
an op-amp having an inverting terminal connected to the emitter terminal of the first transistor for receiving the first voltage, a non-inverting terminal connected to the emitter terminal of the second transistor by way of a first resistor for receiving the second voltage, and an output terminal for generating a control voltage;
a third transistor having a gate terminal connected to the output terminal of the op-amp for receiving the control voltage, a source terminal connected to a biasing voltage, and a drain terminal connected to the emitter terminal of the first transistor by way of second and third resistors for generating a first current;
a fourth transistor having a gate terminal connected to the output terminal of the op-amp for receiving the control voltage, a source terminal connected to the biasing voltage, a drain terminal connected to the emitter terminal of the second transistor by way of fourth and fifth resistors for generating a second current;
a fifth transistor having a gate terminal connected to the output terminal of the op-amp by way of a first switch for receiving the control voltage, a source terminal connected to the biasing voltage, a drain terminal connected to the emitter terminal of the first transistor by way of the second and third resistors for generating a third current, wherein the drain terminal of the fifth transistor generates the third current when the first switch is closed; and
a sixth transistor having a gate terminal connected to the output terminal of the op-amp by way of a second switch for receiving the control voltage, a source terminal connected to the biasing voltage, a drain terminal connected to the emitter terminal of the second transistor by way of the fourth and fifth resistors for generating a fourth current, wherein the drain terminal of the sixth transistor generates the fourth current when the second switch is closed, wherein the drain terminals of the fourth and sixth transistors form a node to output the reference output voltage, and wherein the first through fourth currents control the reference output voltage; and
a voltage monitoring circuit that receives the supply voltage and the reference output voltage and generates a voltage monitor signal, thereby monitoring the supply voltage.

11. The power management controller of claim 10, wherein the first and second transistors comprise bipolar junction transistors (BJT).

12. The power management controller of claim 10, wherein an area of the emitter of the second transistor is at least two times an area of the emitter area of the first transistor.

13. The power management controller of claim 10, wherein the third through sixth transistors comprise metal-oxide semiconductor field effect transistors (MOSFETs).

14. The power management controller of claim 10, wherein a channel width of the third transistor is at least two times a channel width of the fourth transistor, and a channel width of the fifth transistor is at least two times a channel width of the sixth transistor.

15. The power management controller of claim 10, wherein the first through fourth currents are proportional-to-absolute temperature (PTAT) currents.

16. The power management controller of claim 10, wherein the fifth and sixth transistors fine calibrate the reference output voltage by way of the first and second switches.

17. The power management controller of claim 10, wherein the reference voltage generator further includes a third switch connected in parallel with the first resistor, a fourth switch connected in parallel with the third resistor, and a fifth switch connected in parallel with the fifth resistor.

18. The power management controller of claim 17, wherein the first, third, and fifth resistors coarse calibrate the reference output voltage by way of the third through fifth switches.
